(19) United States
(12) Patent Application Publication
(10) Pub. No.: US 2013/0050023 A1
(43) Pub. Date: Feb. 28, 2013

(54) Reconfigurable Active Computational Beamforming Antenna

(71) Applicant: Yann Oster, Frouzins (FR)

(72) Inventor: Yann Oster, Frouzins (FR)

(73) Assignee: THALES, Neuilly-sur-Seine (FR)

(21) Appl. No.: 13/500,508

(22) PCT Filed: Sep. 29, 2010
(86) PCT No.: PCT/EP2010/064508

§ 371 Date: Sep. 10, 2012

(30) Foreign Application Priority Data
Oct. 6, 2009 (FR) 0904772

(51) Int. Cl. H01Q 3/40; H04B 7/185

(52) U.S. Cl. 342/373

(57) ABSTRACT

The invention relates to an apparatus for processing the data from a plurality of digital signals (71) for a system for transmitting and/or receiving active antenna RF signals capable of forming at least one beam (98) by means of computation using a plurality of combiners (501, 502, 503, 511, 512, 513). The apparatus comprises means for processing the digital signal data over a plurality of computational planes in parallel (501-503 and 511-513) and separately between each computational plane. The invention can be used for any type of computational beamforming antenna and preferably for onboard antennas for use in satellites.

The field of the invention relates to reconfigurable active computational beamforming antennas, notably for the antennas intended for onboard applications, for wideband requirements.

The active digital beamforming (DBF) antennas generally consist of digital beamformers in order to meet the mission flexibility needs when a large number of beams (also commonly called “spots”) have to be formed. The mission flexibility relates in particular to the coverage area, the bandwidth and the center frequency for each beam, the power for each beam, the number of beams, and the selection of the radiating elements used. These antennas are particularly well suited to onboard applications for satellite, aircraft or ship type craft for example, requiring dynamic antenna pointing control because of the specific movement of the platform. Using digital processing, these DBF antennas make it possible to perform (to a certain extent) the repointing operation, but also to calibrate and to compensate the physical imperfections of the antenna system, throughout the mission. The digital processing operations can be performed on baseband, or intermediate frequency (IF) digitized signals, or even directly on radiofrequency (RF) carriers. The advantage of the DBF antennas for telecommunication satellite applications can be illustrated as an example. Generally, the mission of the latter is to cover extensive geographic areas by means of a multitude of narrow and contiguous beams, producing a cellular coverage. For certain beams, a higher bandwidth can be assigned, making it possible, for example, to offer high definition video services. The coverage area can also be modified during the lifetime of the satellite, as can the frequency plan for incorporating new linguistic spots for example. The flexibility of the DBF antennas makes it possible to meet the trend of the services while keeping the same hardware architecture. In another example, notably for military telecommunication satellite applications, there may be intentional scramblers to be confronted. A DBF antenna makes it possible on the one hand to identify the direction of the scramblers, and on the other hand to mask (by forcing a zero gain) these directions, in order to improve the signal-to-noise ratio of the considered signals. For the same military applications, the coverage areas are naturally variable to address different theaters of operations during the lifetime of the satellite.

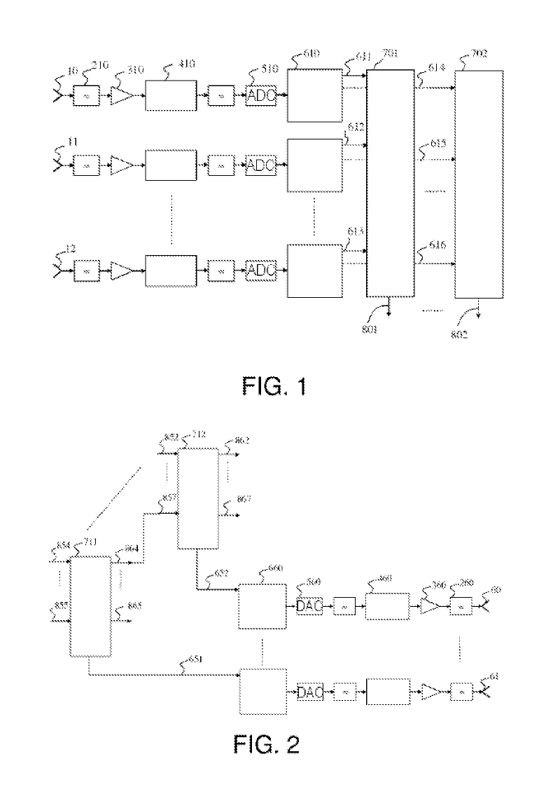

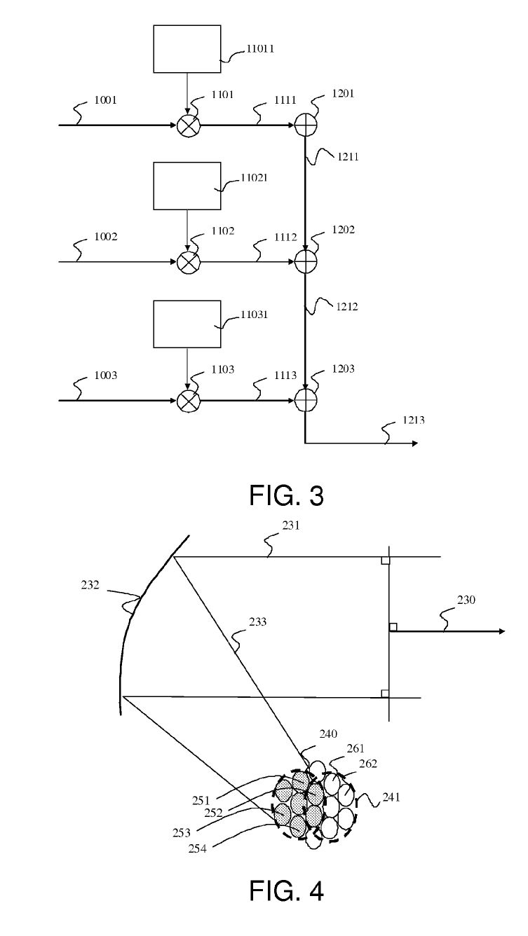

Because of the increasing need in terms of processed bandwidth, it is becoming necessary to increase both the bandwidth for each beam (from a few tens to a few hundreds of MHz) and the number of beams (typically from a few tens to more than a hundred or so beams). The use of DBF antennas requires a large number of radiating elements, typically of the order of a few tens to a few hundreds depending on the antenna type (for example DRA: “Direct Radiating Array”, AFR: “Array Fed Reflector”). The digital processing for beamforming performs a linear combination on the input signals, or respectively the signals obtained from the radiating elements in the reception case, and the beams to be transmitted in the transmission case. The transmission and reception cases are similar and require the same processing operations. The computation functions for beamforming involve a complex weighting coefficient assignment operation, a complex multiplication operation for each beam, for each radiating element and for each data sample, as well as a complex addition to combine the duly computed partial terms. More specifically, as illustrated by FIG. 3, the beamforming function is performed by means of combiners assigning the weighting coefficients 11011, 11021, 11031 and performing the complex multiplication 1101, 1102, 1103 and complex addition 1201, 1202, 1203 operations on the partial terms. These combiners are assembled to perform the different linear combinations corresponding to the beamforming. As illustrated by FIGS. 1 (reception case) and 2 (transmission case), a DBF antenna comprises a set of boards and electronic equipment items 701, 702; 711, 712 incorporating the digital components performing these processing operations. The design of such antennas is problematical for onboard applications, because of the logical complexity and the dissipation of power.

The processed bandwidth associated with the quantity of beams to be formed and with the multitude of radiating elements mobilized induces a very dense connectivity between the computation units (integrated circuits) and high-throughput needs on the interfaces of the digital components. These components are usually ASICs (Application-Specific Integrated Circuits) or FPGAs (Field Programmable Gate Arrays). The input and output interfaces of these components are quickly saturated whereas the capacity in terms of logic gates for implanting the DBF processing operations is under exploited. The result of this is increased hardware complexity, which is not optimal with a large number of components underused. The result of this is an increase in the weight, the bulk, the dissipation and the cost of the systems, raising problems of feasibility given the constraints of the onboard applications. Antennas of DBF type are known, described in the patent application FR2864710 A1 filed on Dec. 24, 2003. This document describes an array architecture for this type of antenna.

To overcome these problems of hardware complexity and dissipation, the consideration of two solutions is generally envisaged. The first solution consists in using the most advanced microelectronic technologies, to benefit from the gains in integration density, in processing speed, in dissipation, and in throughput of the interfaces. However, the cost associated with these technologies regularly increases and may prove prohibitive. Also, the renewal cycles of the microelectronic technologies tend to slow down for etching finenesses less than 90 nm. This solution is proving increasingly inadequate to meet the trend of the requirements regarding computational beamforming. Architecture studies performed to assess the feasibility of future wideband missions (telecommunication satellites) show that the gap is widening between, on the one hand, the trend of the wideband DBF requirements, and, on the other hand, what would be made possible by the technological trend in the medium term, given constant weight and dissipation constraints.

A second solution that can be envisaged lies in the known techniques of optimizing the implantation of the computations when the operands are fixed. In the case of DBF function, this imposes complex weighting coefficients that are fixed in relation to the definition of the circuits. The flexibility inherent to the reprograming of all the weighting coefficients can then be obtained only with reprograming at the circuit level. This solution therefore imposes the use of reconfigurable FPGA components. However, these components have integration capacities much lower than the ASIC components. The number of reconfigurable FPGA components needed for the DBF function would then be too high, compromising the feasibility with respect to the hardware complexity and dissipation.

The patent document WO 2008/075099 “Beamforming system and method”, proposing a solution making it possible to reduce the complexity of implantation of the DBF function, in transmission and/or reception, in the case of active AFR-type antennas, is known. This type of antenna forms a beam with a subset of the feeds, and the proposed solution is to implant a selector (“switch”) of feeds upstream of the DBF, rather than implant a linear combination on all the feeds and force the zero weighting for the unused feeds. Nevertheless, this solution only addresses the case of AFR antennas and does not resolve the problems of congestion of the interfaces of the integrated circuits, in the wideband case and for a large number of beams, resulting in high complexities and dissipation.

The proposed invention makes it possible to resolve all the abovementioned problems associated with multibeam active antennas.

A system for transmitting and/or receiving of multibeam computational beamforming antenna type comprises an array of radiating elements capable of transmitting and/or receiving RF (radiofrequency) signals.

The computational beamforming function applies equally well in transmission and in reception. In reception, a beam is formed by complex linear combination of the digitized data, in baseband, or in IF or directly in RF, obtained, possibly after frequency transposition and filtering, from the RF signals received by a group of radiating elements. In transmission, a beam is formed by generating the excitation signals for the radiating elements by complex linear combination of the digital signals, in baseband or in IF or directly in RF, of the beams to be generated, before digital/analog conversion and possible frequency transposition.

More specifically, the invention relates to an apparatus for processing data from at least one digital signal for a system for transmitting and/or receiving RF signals of active antenna type comprising a plurality of radiating elements and capable of forming at least one beam by computation using a plurality of combiners. For this, the data processing apparatus comprises at least two combiner arrays, at least one vector converter and one inverse converter.

The vector converter comprises an input channel and at least two output channels, and is capable of converting an integer digital datum from a digital signal present on the input channel into a datum in vector representation by at least two components in residue arithmetic on the output channels, one output channel being dedicated to each component.

The inverse converter comprises at least two input channels and one output channel, and is capable of converting the datum in vector representation defined by at least two components in residue arithmetic present on the input channels into an integer digital datum on the output channel, one input channel being dedicated to each component.

The vector converter and the inverse converter are arranged on either side of the combiner arrays and the combiner arrays are arranged so as to process in parallel said components in residue arithmetic to form the beam in reception mode or the excitation signal of a radiating element of the antenna in transmission mode, one combiner array performing the processing operations associated with a specific component in residue arithmetic.

According to any one of the vector representation modes, a first component in residue arithmetic is represented in an integer format on a first dynamic and a second component in residue arithmetic is represented in an integer format on a second dynamic. The integer digital datum present on the input of a vector converter is represented in an integer format on a dynamic equal to m, and the dynamic of a component in residue arithmetic represented in an integer format is strictly less than m.

In residue arithmetic, the integer numbers are represented by vectors, and the arithmetic processing operations are vectorized: performed independently by components, or computation plane. Instead of conventionally performing the operations on integers on n bits (implicitly modulo 2ⁿ), the computations are performed in parallel on r integer components, modulo respectively m₁, m₂, . . . mᵣ. The choice of modulus base {m₁, m₂, . . . mᵣ} has to satisfy two conditions: on the one hand, the moduli mᵢ have to be coprimes, and, on the other hand, the product of all the moduli has to be greater than 2ⁿ to represent an integer dynamic on n bits. Each computation plane (i) performs the processing operations modulo one integer mᵢ, with a specific dynamic mᵢ well below 2ⁿ. This system of vectorized representation of the numbers in residue arithmetic is also commonly called “residue number system” (RNS).

Advantageously, a combiner array processes the first component independently of the second component.

Advantageously, the apparatus comprises, for the forming of a beam, a number of independent combiner arrays equal to the number of components in residue arithmetic obtained from a vector converter.

The DBF function comprises as many independent combiner arrays for each beam as the dimension of the base (at least two) chosen to perform the processing operations in residue arithmetic. Thus, on a functional plane, an antenna in reception generating N beams, from i radiating elements, in residue arithmetic with r components, will implant N*r arrays of i combiners, associated with i vector converters (1:r) and N inverse converters (r:1), each function being dimensioned to process the throughput corresponding to the bandwidth required for each beam. However, those skilled in the art can adapt the use of the physical resources to the functional need to optimize the complexity.

According to a first variant of the invention, the apparatus comprises at least one type of implementation means integrating the vector converters, the inverse converters and the combiner arrays capable of processing the first and the second component. The expression “type of implementation means” should be understood to mean any type of electronic components such as FPGA or ASIC circuits, or a set of electronic components forming an electronic circuit board or a sub-equipment item comprising a number of boards.

According to a second variant of the invention, more modular and suited to the wideband DBF requirement, the apparatus comprises at least three types of implementation means, a first implementation means being dedicated to the integration of combiner arrays, a second implementation means being dedicated to the integration of the vector converters and a third implementation means being dedicated to the integration of the inverse converters. This implantation makes it possible to optimize the complexity and dissipation, the dimensionings of these three functions being specific. The interfaces (inputs and/or outputs) of the different implementation means (boards/circuits) are then, in residue arithmetic, identifiable by the coding of the data and the different dynamics of the components in residue arithmetic.

According to a variant, the DBF function forms all the beams on one and the same bandwidth or in another, more effective variant, the apparatus also comprises digital signal processing means, notably means for multiplexing narrowband digital signals and/or means for demultiplexing a wideband digital signal, capable of being arranged upstream or downstream of the combiner arrays in the data processing chain formed by the combiner arrays and said processing means.

The vector converters can be arranged upstream of these digital signal processing means and the inverse converters downstream of the digital signal processing means, the digital signal processing means processing the data also in residue arithmetic. However, the DBF function may be the only one to process the data in vectorized representation, the vector converters being arranged directly upstream of the DBF function and the inverse converters directly downstream of the DBF function.

Thus, the DBF function can form the beams on different bandwidths, respectively downstream of a frequency demultiplexer or filter bank in the reception case, and upstream of a frequency multiplexer in the transmission case. Advantageously, the hardware resources and the power dissipation are mobilized only to process the considered signal (frequency channel associated with a direction). Advantageously, the individual combiner arrays are dimensioned to process the throughput corresponding to the individual frequency band of the demultiplexer or of the frequency multiplexer, to optimize the complexity and the dissipation. The combiner arrays are then assembled on four dimensions: by RNS components, by beams, by radiating elements, and by individual frequency band.

According to a variant of the apparatus for an antenna comprising a plurality of radiating elements and capable of forming at least two beams from n radiating elements, at least one radiating element being common for the forming of said beams, the combiners processing the same component of the digital signal data obtained from said radiating element common to said beams are implemented in one and the same electronic component.

In the case of the DBF antennas comprising a lens or a reflector, for example an AFR-type antenna, all the radiating elements do not necessarily contribute to forming each beam, unlike in the DRA case. Any radiating element generally contributes to forming a set of adjacent beams in the reception case and, symmetrically, any beam contributes to the excitation of a set of adjacent radiating elements in the transmission case. Advantageously for this type of antenna, by pooling the interfaces, that is to say by combining the processing operations sharing the same data as input, the implantation of the DBF in residue arithmetic makes it possible, because of the reduced complexity (in terms of surface area and of throughput at the interfaces) for each computation plane, to integrate a greater number of processing operations for each ASIC/FPGA circuit, resulting in a reduced dissipation and overall complexity.

According to a variant, a digital apparatus/board/combiner array type circuit implants combiners for a subset of the computation planes. Advantageously, this option makes it possible to relax the constraint on throughput at the interfaces, at the apparatus, electronic circuit board and ASIC/FPGA components level.

According to a variant, an apparatus/board/digital circuit of combiner array type implants combiners on all the computation planes. Advantageously, all the combiner arrays of the DBF can be implanted with one and the same type of apparatus, even with one and the same type of ASIC/FPGA, to optimize the development and production costs.

Despite the additional complexity induced by the vector and inverse converters, this vectorized representation is particularly advantageous for the wideband DBF function, involving a large number of multipliers and operating at high throughput. In practice, the parallelism makes it possible to speed up the arithmetic processing operations on a number of computation planes of lesser complexity, with a reduced dynamic for each computation plane, which also reduces the throughput at the interface of the processing functions for each computation plane. The implantation granularity is greatly enhanced, as much on the plane of interfaces (functional throughput reduced together with the dynamic) as on the plane of the logical complexity of the individual processing operations (operations on reduced dynamics), which makes it possible to better exploit the integration capacities of the ASIC and/or FPGA components, resulting in a lesser complexity of implantation of the DBF function. Also, the dissipation and the processing speed of the DBF function are also enhanced by virtue of the reduced dynamic of the individual operators (adders, multipliers).

According to a variant, the vector converters, the inverse converters and the combiners are designed by means of FPGA type components. In practice, the reduced granularity of the individual computation functions makes it possible to use FPGAs, which offer a lesser integration capacity than the ASICs.

The implementation of DBF functions according to the invention offers a number of advantages compared to the conventional techniques in the case of requirements that are demanding in terms of beams, radiating elements and wideband.

A first advantage in the subdividing of the processing operations by independent computation planes is the significant reduction of the throughput at the interfaces for each individual combiner function, which generally constitutes a factor limiting the effectiveness of the hardware architectures.

A second advantage, extending the first, is the reduction in the granularity of implantation of the individual combiner function, in terms of surface area, and in terms of dissipation, as well as in terms of interface, allowing for a better use of the hardware resources, for a lesser complexity and overall dissipation.

A third advantage, linked to the second, is the introduction of a new modularity dimension, by computation plane, complementing the dimensions by beam, by radiating element, and by individual frequency band, for a greater design flexibility and modularity. For example, an ASIC performing DBF processing operations on a particular computation plane (modulo 13, etc.) can be reused if the overall computation dynamic had to change for another DBF antenna.

A fourth advantage, also resulting from the second, is the possibility of using less powerful microelectronic technologies, FPGAs or ASICs of lesser integration capacity or that are less fast, to reduce the costs.

A fifth advantage, inherent to the reduced dynamic by computation plane and to the simplification of the arithmetic operators, is the reduction in dissipation associated with an enhancement of the critical operating frequency.

A sixth advantage, linked to the first, makes it possible to integrate more DBF processing operations for each integrated circuit, by pooling the interfaces for the processing operations concerning one and the same set of inputs, in the case of the DBF AFR antennas or antennas comprising a lens.

The invention therefore makes it possible to achieve the aims sought for the onboard applications.

The invention will be better understood and other advantages will become apparent from reading the following description given as a nonlimiting example and by virtue of the appended figures in which:

FIG. 1 represents the block diagram of the data processing chain of a DBF antenna in reception mode.

FIG. 2 represents the block diagram of the data processing chain of a DBF antenna in transmission mode.

FIG. 3 represents the block diagram of the digital channel forming processing, common to both transmission and reception modes.

FIG. 4 represents a DBF antenna of AFR type, and the illumination of the feeds by the focal spots.

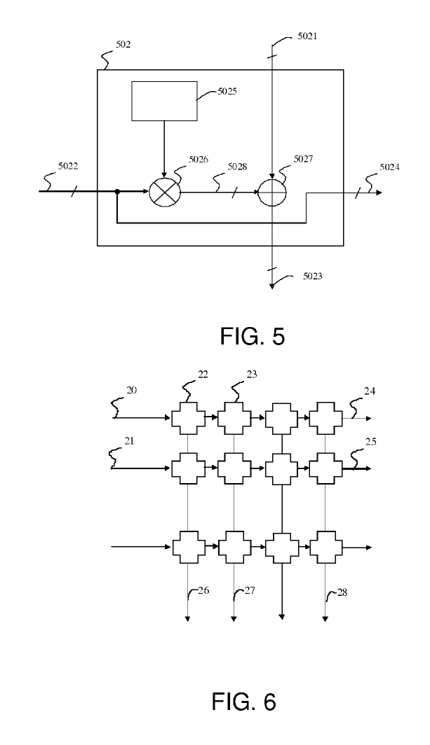

FIG. 5 represents the block diagram of an individual combiner, computing and accumulating a partial term of the DBF computation.

FIG. 6 represents an example of matrix assembly of the combiners to form a set of channels from one and the same set of inputs.

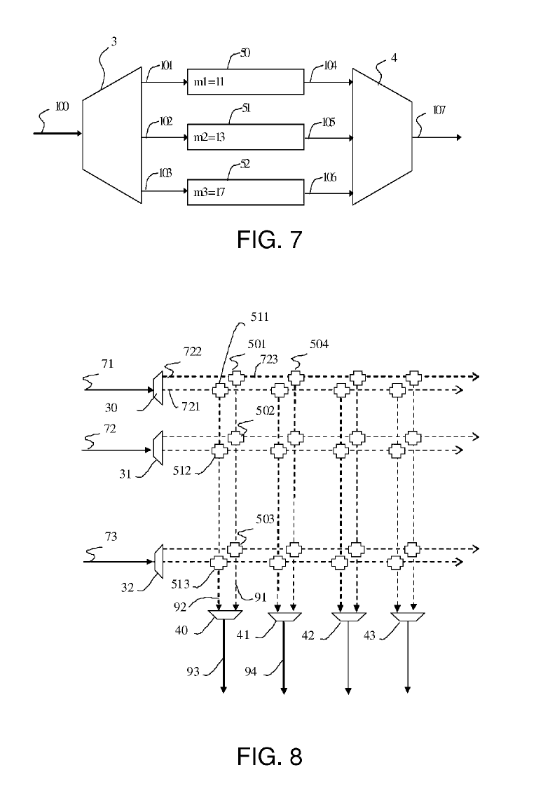

FIG. 7 represents a block diagram of digital processing in RNS.

FIG. 8 represents the block diagram of an implementation of DBF processing in RNS.

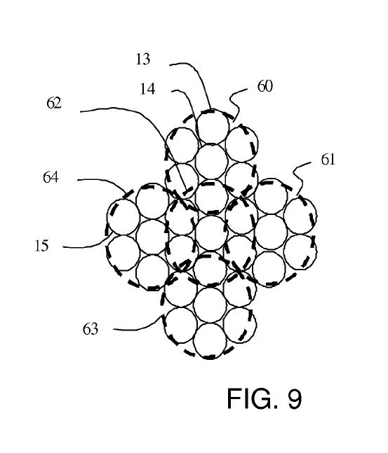

FIG. 9 represents the pooling of the interfaces (radiating elements in the reception case) to effectively form adjacent beams.

The invention applies to the active DBF antennas of DRA type and the antennas comprising a reflector (FAFR, standing for “Focal Array Fed Reflector” and AFR, standing for “Array Fed Reflector”, for example). It applies to any active DBF antenna and preferably to the antennas comprising an array of radiating elements consisting of a large number of feeds, that is to say, by way of indication, up to more than a hundred or so, and intended to form a multitude of wideband beams, that is to say, by way of indication, up to a hundred or so beams over a frequency band of approximately 100 to 500 MHz. However, the latter indications in no way limit the scope of the invention. The invention applies advantageously to more complex antennas that may comprise a greater number of radiating elements and that can transmit and/or receive a greater number of beams over wider frequency bands. The embodiment described hereinbelow relates in particular to an onboard antenna for satellites.

As represented in FIG. 1, the antenna in reception mode according to the invention comprises radiating elements 10, 11, 12, connected to analog input chains performing operations for filtering 210, amplification 310, possibly frequency transposition 410 into intermediate frequency or into baseband, analog/digital converters 510, possibly frequency demultiplexing functions 610, and computational beamforming functions 701, 702. The digital signal at the output of the ADC is wideband. The channeling by frequency demultiplexing 610 can be performed before or after the DBF. In an advantageous embodiment, the channeling is performed before the DBF, which then processes a multitude of narrowband signals 611, 612, 613. The outputs 611, 614 of each frequency demultiplexer 610 are connected to the inputs of a set 701, 702 of beamformers, which generate the digital signals 801, 802 resulting from the spatial filtering producing the antenna gain in the desired directions.

Symmetrically, as represented in FIG. 2, the antenna in transmission mode according to the invention comprises radiating elements 60, 61, connected to analog output chains performing operations for filtering 260, amplification 360, frequency transposition 460, digital/analog converters 560, possibly frequency multiplexing functions 660, and computational beamforming functions 711, 712. The digital signal at the input of the DAC is wideband. The frequency multiplexing 660 can be performed before or after the DBF. In an advantageous embodiment, the frequency multiplexing is performed after the DBF, which then processes a multitude of narrowband signals 852, 857, 862, 867. The inputs of each frequency multiplexer 660 are connected to the outputs 652, 651 of a set 711, 712 of beamformers which construct the excitation signal for a radiating element, in an individual frequency band.

The DBF digital processing, also called channel forming, is identical in transmission and in reception, and corresponds to a complex linear combination on the inputs. As illustrated by FIG. 3 for three inputs, the input signals 1001, 1002 and 1003 are weighted with the allocated complex coefficients 11011, 11021, 11031 by the complex multipliers 1101, 1102 and 1103 whose outputs 1111, 1112 and 1113 are summed in the adders 1201, 1202, 1203, producing partial terms 1211, 1212, 1213. The last partial term 1213 of the summing chain then corresponds to the output of the DBF function. In an advantageous embodiment, this regular assembly of combiners makes it possible to perform DBF processing operations of varying complexities with one and the same individual module. An individual combiner comprises a complex multiplier and a complex adder, and computes the partial term for one input and one channel.

FIG. 5 represents a combiner 502 performing the computation of the partial term for one functional input and one channel. This individual circuit comprises two inputs, for, respectively, the considered signal 5022 and the partial summing of the partial terms upstream 5021, and one or two outputs, for, respectively, the new aggregated partial term 5023, and, optionally, to propagate as output 5024 the considered signal 5022 to other combiners. Advantageously, this propagation of the considered signal 5022/5024 between combiners makes it possible to manage the distribution of the signals, particularly in the case of a large number of combiners, and allows for a modular architecture for the DBF function. The individual combiner comprises a complex multiplier 5026 which weights the input signal 5022 by a coefficient 5025, the result 5028 then being summed, via an adder 5027, with the partial term upstream 5021 to produce the aggregated partial term at the output 5023.

As illustrated by FIG. 6, the combiners 22, 23 are assembled as a matrix in order to form a set of channels 26, 27, 28 from a set of inputs 20, 21. According to this modular architecture, the considered signal of each input 20, 21 is propagated step by step between adjacent combiners. FIG. 6 presents the particular case of a regular assembly according to which each input contributes to the forming of all the channels, as in the case of the DRA antennas or certain AFR antennas.

As represented by FIG. 4, an AFR antenna consists of a reflector 232 which reflects the incident rays 231 corresponding to a direction 230, onto a set of feeds or radiating elements, according to a focal spot 240. The radiating elements 251, 252, 253, 254 illuminated by the focal spot corresponding to the direction 230 are then mobilized to form the beam in that direction. Other radiating elements 261, 262 correspond to other focal spots 241 for other beams. Adjacent beams correspond to adjacent or superposed focal spots, with radiating elements 252 in common. In an advantageous embodiment, the DBF processing of adjacent beams is implemented in one and the same circuit or set of circuits, in order to limit the replication of the data on the external inputs/outputs of different circuits, by pooling the interfaces, this being done in order to optimize the complexity and the dissipation.

FIG. 7 represents the block diagram of an implantation in residue arithmetic (RNS), for linear digital processing operations based on additions and multiplications, on integer signals. The input signal 100 is first of all converted in the RNS base (selected to support the required dynamic), using a vector converter 3 which generates the RNS components 101, 102, 103 of the considered signal 100. Then, the functional processing operations are performed in parallel and independently on the different computation planes 50, 51, 52, modulo the respective moduli of the RNS base. The components in residue arithmetic 104, 105, 106 of the result obtained on the different computation planes are finally converted into integer signal 107, according to the desired representation, using an inverse converter 4. In FIG. 7, the RNS base retained comprises three components, computed modulo {11, 13, 17}, and allows for a maximum dynamic of 11*13*17=2431, compatible with conventional binary arithmetic on 12 bits (2¹²=2048<2431). The modulo 11 and modulo 13 computation planes require an integer representation on 4 bits, whereas the modulo 17 computation plane requires 5 bits. Advantageously, the arithmetic processing operations are performed in parallel and independently on three planes with partial dynamics corresponding to 4 or 5 bits in place of a single computation channel on 12 bits. Each computation plane is differentiated by its specific and explicit dynamic, which can be observed on the output interfaces.

FIG. 8 describes an RNS implantation of the DBF function forming a set of channels 93, 94 (beams formed in reception, excitation signals for the radiating elements formed in transmission) for a set of inputs 71, 72, 73 (signals from the radiating elements in the reception case, signals associated with the beams to be generated in transmission). The vector converters 30, 31, 32 are connected between the functional inputs 71, 72, 73 and a number of computation planes integrating combiner arrays (501, 502, 503, . . . ), (511, 512, 513, . . . ). Each vector converter comprises an input channel 71 in integer representation and a number of output channels for the components 722, 721 in residue representation. The functional input 71 is connected to the input of the vector converter 30, the combiner 501 is linked to the first output channel 722 of the converter and the combiner 511 is linked to the second output channel 721 of the converter. The combiners 501 form part of a first combiner array (501, 502, 503, . . . ) making it possible to process data in a first data format in residue representation. The combiner 511 forms part of a second combiner array (511, 512, 513, . . . ) making it possible to process data in a second data format in residue representation.

The first combiner array is connected as follows. An input channel of the combiner 501 is linked to an output channel of the converter 30 and an output channel is connected to an input channel of the combiner 502. An input channel of the combiner 502 is linked to an output channel of the converter 31 and an output channel of the combiner 502 is linked to an input channel of the combiner 503. An input channel of the combiner 503 is linked to an output channel of the converter 32 and an output channel 91 of the combiner 503 is linked to an input channel of the inverse converter 40. Another combiner array is arranged similarly with the converters 30, 31 and 32 and the inverse converter 40. The channel 1 generated by the DBF function, obtained from the inverse converter 40, is formed by means of the abovementioned combiner arrays, each of the arrays independently processing data in a distinct format.

Other beams can be generated from the same functional inputs 71, 72, 73 contributing to the forming of the channel 1. For this, for each of the channels, a number of combiner arrays are implemented and linked to the other combiner arrays belonging to one and the same computation plane. For example, three other channels are derived from the inverse converters 41, 42 and 43 and, for each of the channels, a number of combiner arrays, processing data of distinct formats corresponding to the different computation planes, are arranged in the same way as the arrays forming the channel 1. The combiner arrays contributing to different channels and belonging to one and the same computation plane are interconnected, either by a direct distribution from each RNS component of the vector converters to all the associated combiners, or by propagation of each component step by step between adjacent combiners, as illustrated in FIG. 8. For this, an output channel 723 of the combiner 501 is linked to an input channel of the combiner 504 contributing to the forming of the channel 2, and so on for the adjacent combiner arrays. The combiners 502, 503, 511, 512, 513 are also connected to other combiners belonging to combiner arrays intended to form other channels from the same functional inputs 71, 72, 73.

More generally, the combiners associated with one and the same computation plane, with a set of functional inputs, and for the forming of one and the same channel, are interconnected to accumulate the partial terms and constitute a combiner array. The combiners belonging to different computation planes do not share interconnections. The combiners processing data of the same format and contributing to the forming of different channels from the same functional inputs are interconnected to propagate the RNS components of the functional input signal.

These different combiner arrays perform processing operations independently and in parallel, on reduced partial dynamics. They can be implanted on integrated circuits or on different electronic equipment items, the digital processing operations associated with one and the same functional input then being able to be distributed over distinct equipment items. According to another hardware organization, the processing operations are divided up by channel and/or sets of functional inputs in order to integrate all the RNS components within one and the same integrated circuit or electronic equipment item, to reduce the development costs without sacrificing modularity. Specific equipment items integrate the vector converters and the inverse converters, in particular in the case of complex DBF antennas, with a large number of radiating elements, for a large number of beams, in wideband mode. All these electronic equipment items (vector converters, inverse converters and DBF processing operations) then comprise interfaces characteristic of data in residue representation, with components on specific dynamics, corresponding to coprime moduli.

As illustrated in FIG. 3, the conventional DBF antennas comprise a single combiner array for each channel (1101, 1201), (1102, 1202), (1103, 1203), the array processing data in conventional integer arithmetic on dynamics of 10 to 16 bits or more. With an embodiment according to the invention, the implementation of the DBF processing operations is divided up over a number of independent computation planes with partial dynamics reduced to a few bits, which makes it possible to greatly reduce the density of interconnections at the logic operator level. This advantageously results in a lesser surface complexity, a simplified placement and routing of the integrated circuits, a lesser dissipation and a higher operating frequency.

Another significant advantage, resulting from the dividing up of the processing operations on computation planes with greatly reduced partial dynamics, relates to the finer granularity of implantation of the combiners, in terms of surface complexity, of dissipation and of throughput at the interfaces. The gain in implantation granularity allows for a better use of the hardware resources to jointly reduce the complexity and the dissipation of the DBF function.

In the case of reflector or lens antennas, this advantage can be amplified by grouping together by circuit the processing operations relating to a set of channels (beams in reception, radiating elements in transmission) formed from shared functional inputs (radiating elements in reception, beams in transmission). In practice, by thus pooling the interfaces, the distribution of the functional input signals is then achieved at the board level and within processing integrated circuits. This makes it possible to even further relax the throughput limitation at the interfaces of the circuits. FIG. 9 represents an example of pooling of the radiating elements by the embodiment of the invention. The array of twenty nine radiating elements 13, 14, 15, . . . makes it possible to form five beams corresponding to the focal spots 60, 61, 62, 63, 64. By integrating the combiners associated with these five adjacent beams in one and the same ASIC/FPGA circuit, for one or more computation planes, this represents an average throughput of data at the input corresponding to 5.8 radiating elements for each beam, assuming 7 radiating elements for each independent beam. This hardware organization therefore makes it possible to integrate a greater number of combiners for each integrated circuit, given the throughput limitation at the interfaces, for a reduced overall complexity and dissipation.

Depending on the need to be satisfied in terms of quantity of beams, radiating elements and processed bandwidth, and depending on the integration capacity of the ASIC/FPGA technology selected, the implementation according to the invention of the DBF function can make it possible to integrate processing operations of at least one complete computation plane, for all the channels to be formed, within a single ASIC/FPGA. This means that the circuit can perform processing operations on an RNS component, for at least one functional input and for all the channels formed with this functional input. In this case, it is no longer necessary to allocate external interfaces of the circuit to propagate the functional input signals to the output, which therefore makes it possible to further increase the integration of combiner functions, this integration being generally limited by the capacity in terms of interfaces.

According to the variants of the invention for which the DBF function forms beams on one and the same bandwidth, for a DBF antenna in reception, a digital signal from a radiating element is connected to the input channel of a vector converter, the output channels of said converter are connected to the input channels of a set of combiner arrays, the output channels of said combiner arrays are connected to the input channels of an inverse converter, the output of which produces a beam.

According to the variants of the invention for which the DBF function forms beams on one and the same bandwidth, for a DBF antenna in transmission, a digital signal corresponding to a beam to be transmitted is connected to the input channel of a vector converter, the output channels of said converter are connected to the input channels of a set of combiner arrays, the output channels of said combiner arrays are connected to the input channels of an inverse converter, the output of which produces the excitation signal for a radiating element.

According to an embodiment as represented by FIGS. 1 and 2, the data processing equipment also comprises data processing means 610 and 660, in addition to the DBF function, respectively performing the frequency demultiplexing and multiplexing functions. The vector conversion and inverse conversion functions can be arranged according to various organizations around the DBF function, the frequency demultiplexing and multiplexing functions so that the latter two functions are performed on data in vectorized representation or in conventional representation. According to a first arrangement in which the frequency demultiplexing and multiplexing functions are performed on data in vectorized representation, then the data processing means performing the latter functions are arranged between the vector converters and the associated inverse converters. According to a second arrangement in which the frequency demultiplexing and multiplexing functions are performed on data in conventional representation, then the data processing means performing the latter functions are arranged around the part of the data processing chain positioned between the vector converters and the associated inverse converters.

The implementation of the invention involves the use of a particular data processing method. For this, the computation method for forming a beam comprises the following successive steps in transmission and/or reception mode:
conversion of data represented in an integer format to a data format in residue representation,
processing of the data from one and the same vector converter, in parallel and in residue representation, for the forming of a beam in reception mode or the excitation signal of a radiating element of the antenna in transmission mode,
inverse conversion of the data in a format in residue representation to a desired data format.

Detailed studies of antenna hardware architectures according to the invention have made it possible to demonstrate a significant reduction in the complexity, the number of integrated circuits needed, and the overall dissipation, compared to the existing solutions. The implementation of DBF functions according to the invention therefore makes it possible to satisfy demanding requirements in terms of quantity of beams, radiating elements and processed bandwidth, by optimizing the hardware complexity and dissipation. The invention applies to any DBF antenna for space applications as described in the preferred embodiment, but also to any onboard applications subject to complexity and dissipation constraints, notably telecommunication satellites.

1. An apparatus for processing data from at least one digital signal for a system for transmitting and/or receiving RF signals of active antenna type comprising a plurality of radiating elements and capable of forming at least one beam by computation using a plurality of combiners, further comprising:
at least two combiner arrays , at least one vector converter and one inverse converter,
wherein the vector converter comprises an input channel and at least two output channels, and is capable of converting an integer digital datum of the digital signal present on the input channel into a vector representation by at least two components in residue arithmetic on the output channels, one output channel being dedicated to each component,
wherein the inverse converter comprises at least two input channels and one output channel, and is capable of converting the datum in vector representation defined by at least two components in residue arithmetic present on the input channels into an integer digital datum on the output channel, one input channel being dedicated to each component, and
the vector converter and the inverse converter being arranged on either side of the combiner arrays and the combiner arrays being arranged so as to process in parallel said components in residue arithmetic to form the beam in reception mode or the excitation signal of a radiating element of the antenna in transmission mode, one combiner array performing the processing operations associated with a specific component in residue arithmetic.

2. The apparatus as claimed in claim 1, wherein a first component in residue arithmetic is represented in an integer format on a first dynamic and a second component in residue arithmetic is represented in an integer format on a second dynamic.

3. The apparatus as claimed in claim 2, wherein the integer digital datum present on the input of a vector converter is represented in an integer format on a dynamic equal to m and in that the dynamic of a component in residue arithmetic represented in an integer format is strictly less than m.

4. The apparatus as claimed in claim 3, wherein a combiner array processes the first component independently of the second component.

5. The apparatus as claimed in claim 4, further comprising, for the forming of a beam, a number of independent combiner arrays equal to the number of components in residue arithmetic obtained from a vector converter.

6. The apparatus as claimed in claim 5, further comprising at least three types of implementation means, a first implementation means being dedicated to the integration of combiner arrays, a second implementation means being dedicated to the integration of the vector converters and a third implementation means being dedicated to the integration of the inverse converters.

7. The apparatus as claimed in claim 5, further comprising at least one type of implementation means integrating the vector converters, the inverse converters and the combiner arrays capable of processing the first and the second component.

8. The apparatus as claimed in claim 5 for an antenna capable of forming at least two beams from n radiating elements, at least one radiating element being common for the forming of said beams, wherein the combiners processing the same component of the digital signal data obtained from said radiating element common to said beams are implemented in one and the same electronic component.

9. The apparatus as claimed in claim 5 further comprising digital signal processing means, notably means for multiplexing narrowband digital signals and/or means for demultiplexing a wideband digital signal, capable of being arranged upstream or downstream of the combiner arrays in the data processing chain formed by the combiner arrays and said processing means, wherein the vector converters are arranged upstream of the digital signal processing means and the inverse converters downstream of the digital signal processing means, the digital signal processing means processing datas in residue arithmetic.

10. A system for transmitting and/or receiving RF signals, called multibeam active antenna, further comprising an apparatus as claimed in claim 1.

11. A telecommunication satellite, further comprising a system as claimed in claim 10.
